(19) United States
(12) Patent Application Publication
(10) Pub. No.: US 2023/0350033 A1
(43) Pub. Date: Nov. 2, 2023

(54) OPTICAL MEASUREMENT SYSTEM AND METHOD OF MEASURING A DISTANCE OR SPEED OF AN OBJECT

(71) Applicant: ams-OSRAM International GmbH, Regensburg (DE)

(72) Inventor: Hubert HALBRITTER, Dietfurt-Toeging (DE)

(21) Appl. No.: 18/044,389

(22) PCT Filed: Aug. 23, 2021
(86) PCT No.: PCT/EP2021/073223

§ 371 Date: Mar. 8, 2023

(30) Foreign Application Priority Data
Sep. 9, 2020 (DE) 102020123557

(51) Int. Cl. G01S 7/4912; G01S 7/4911; G01S 7/4914; G01S 17/58; G01S 7/481

(52) U.S. Cl. CPC G01S 7/4917; G01S 7/4911; G01S 7/4914; G01S 17/58; G01S 7/4815; G01S 7/4818

(57) ABSTRACT

An optical measurement system may include a device for emitting electromagnetic radiation, comprising a plurality of laser elements. The optical measurement system may include an optical element, comprising a first waveguide and adapted to transmit a first partial beam of irradiated electromagnetic radiation and to incouple a second partial beam of the electromagnetic radiation into the first waveguide at a first position and to outcouple the second partial beam from the first waveguide at a second position. The optical measurement system moreover comprises a plurality of detectors for detecting signals which are generated by superimposing electromagnetic radiation reflected by an object and electromagnetic radiation outcoupled from the first waveguide.

### CROSS-REFERENCE TO RELATED APPLICATIONS

The present application is a national stage entry according to U.S.C. § 371 of PCT application No.: PCT/EP2021/073223 filed on Aug. 23, 2021; which claims priority to German patent application DE 10 2020 123 557.7, filed on Sep. 9, 2020; all of which are incorporated herein by reference in their entirety and for all purposes.

### TECHNICAL FIELD

An optical measurement system and method of measuring a distance of speed of an object are specified, in particular, a first partial beam is reflected by an object and coherently superimposed with electromagnetic radiation outcoupled from a first waveguide to obtain a mixed signal that is then detected by an array of a plurality of detectors.

### BACKGROUND

LIDAR (“Light Detection and Ranging”) systems, in particular FMCW (“Frequency Modulated Continuous Wave”) LIDAR systems are increasingly being used in vehicles, for example for autonomous driving. For example, they are used for measuring distances or for recognizing objects. In order to be able to reliably detect objects at greater distances, laser light sources of appropriately high power are required. In general, attempts are being made to improve existing LIDAR systems.

It is an objective to provide an improved optical measurement system for determining the speed or the distance of an object.

### SUMMARY

According to embodiments, the object is achieved by the subject matter of the independent patent claims. Further developments are defined in the dependent claims.

An optical measurement system comprises a device for emitting electromagnetic radiation, comprising a plurality of laser elements. The optical measurement system further comprises an optical element, comprising a first waveguide and adapted to transmit a first partial beam of irradiated electromagnetic radiation and to incouple a second partial beam of electromagnetic radiation into the first waveguide at a first position and to outcouple the same from the waveguide at a second position. The optical measurement system furthermore comprises a plurality of detectors for detecting signals which are generated by superimposing electromagnetic radiation reflected by an object and electromagnetic radiation outcoupled from the first waveguide.

For example, the optical measurement system may comprise a device which is adapted to branch off the second partial beam upstream of the optical element and incouple the same into the first waveguide.

According to embodiments, the optical measurement system comprises a plurality of waveguide elements which are arranged in a beam path upstream of the detectors and which are adapted to feed the signals to be detected to the plurality of detectors.

The waveguide elements may be single-mode waveguide elements.

The optical measurement system may also comprise a second optical element between the optical element and the plurality of waveguide elements.

According to embodiments, the optical measurement system furthermore comprises a plurality of optical micro elements, each associated with a detector and arranged upstream thereof. For example, the optical micro elements may be arranged directly upstream of the detectors. According to further embodiments, they may also be arranged upstream of a respective one of the waveguide elements.

For example, the optical element may comprise an opaque area at the second position on the side facing the object.

The optical measurement system may further comprise evaluation electronics adapted to determine a difference frequency between a frequency of the reflected radiation and the electromagnetic radiation outcoupled from the first waveguide. For example, the evaluation electronics may comprise a pixel readout circuit associated with a respective one of the detectors.

According to further configurations, the evaluation electronics may also be a detector readout circuit associated with the array of detectors.

Furthermore, the optical measurement system may comprise a modulation device which is adapted to modify a wavelength of the emitted electromagnetic radiation.

For example, the laser elements are each embodied as laser diodes, and the modulation device comprises a current source and is adapted to modify a current intensity impressed into the laser elements.

According to embodiments, several of the plurality of laser elements are capable of being controlled simultaneously. In this manner, a large-area object may be irradiated or analyzed in a simple manner and at little time expenditure.

A LIDAR system comprises the optical measurement system as described above.

A method of operating a measurement system as described above comprises simultaneously impressing a current into a plurality of the laser elements, as a result of which electromagnetic radiation is respectively emitted, detecting a photocurrent by the detectors, thereby determining a detection signal; and determining, from the detection signal, a positional relationship or a change in the positional relationship between an object, which reflects the electromagnetic radiation, and the device for emitting electromagnetic radiation.

For example, the detection signal may be a periodic signal from which a difference between a frequency of electromagnetic radiation emitted by the laser element and the frequency of the electromagnetic radiation reflected by the object may be determined.

### BRIEF DESCRIPTION OF THE DRAWINGS

The accompanying drawings serve to provide an understanding of example embodiments. The drawings illustrate example embodiments and, together with the description, serve for explanation thereof. Further example embodiments and many of the intended advantages will become apparent directly from the following detailed description. The elements and structures shown in the drawings are not necessarily shown to scale relative to each other. Like reference numerals refer to like or corresponding elements and structures.

FIG. 1 shows a schematic view of an optical measurement system according to embodiments.

FIG. 2A shows a schematic view of an optical measurement system according to further embodiments.

FIG. 2B shows the schematic structure of an optical element according to embodiments.

FIG. 3A schematically illustrates the beam path when impinging on a waveguide element.

FIG. 3B illustrates further details of the optical measurement system.

FIG. 3C illustrates further details of the optical measurement system according to the embodiment.

FIG. 4A illustrates an optical measurement system according to further embodiments.

FIG. 4B illustrates an optical measurement system according to further embodiments.

FIG. 5A shows an optical measuring system according to further embodiments.

FIG. 5B shows an optical measuring system according to further embodiments.

FIG. 6A shows the structure of an array of detectors according to embodiments.

FIG. 6B shows the schematic structure of an array of detectors according to further embodiments.

FIG. 6C shows a schematic structure of an array of detectors according to further embodiments.

FIG. 6D shows the schematic structure of an array of detectors according to further embodiments.

FIG. 7 outlines a method according to embodiments.

### DETAILED DESCRIPTION

In the following detailed description, reference is made to the accompanying drawings, which form a part of the disclosure and in which specific embodiments are shown for purposes of illustration. In this context, directional terminology such as “top”, “bottom”, “front”, “back”, “over”, “on”, “in front”, “behind”, “leading”, “trailing”, etc. refers to the orientation of the figures just described. As the components of the example embodiments may be positioned in different orientations, the directional terminology is used by way of explanation only and is in no way intended to be limiting.

The description of the embodiments is not limiting, since other embodiments may also exist and structural or logical changes may be made without departing from the scope as defined by the claims. In particular, elements of the embodiments described below may be combined with elements from others of the embodiments described, unless the context indicates otherwise.

As used herein, the terms “have”, “include”, “comprise”, and the like are open-ended terms that indicate the presence of said elements or features, but do not exclude the presence of further elements or features. Indefinite articles and definite articles include both the plural and the singular, unless the context clearly indicates otherwise.

In the context of this description, the term “electrically connected” means a low-ohmic electrical connection between the connected elements. The electrically connected elements need not necessarily be directly connected to one another. Further elements may be arranged between electrically connected elements.

The term “electrically connected” also encompasses tunnel contacts between the connected elements.

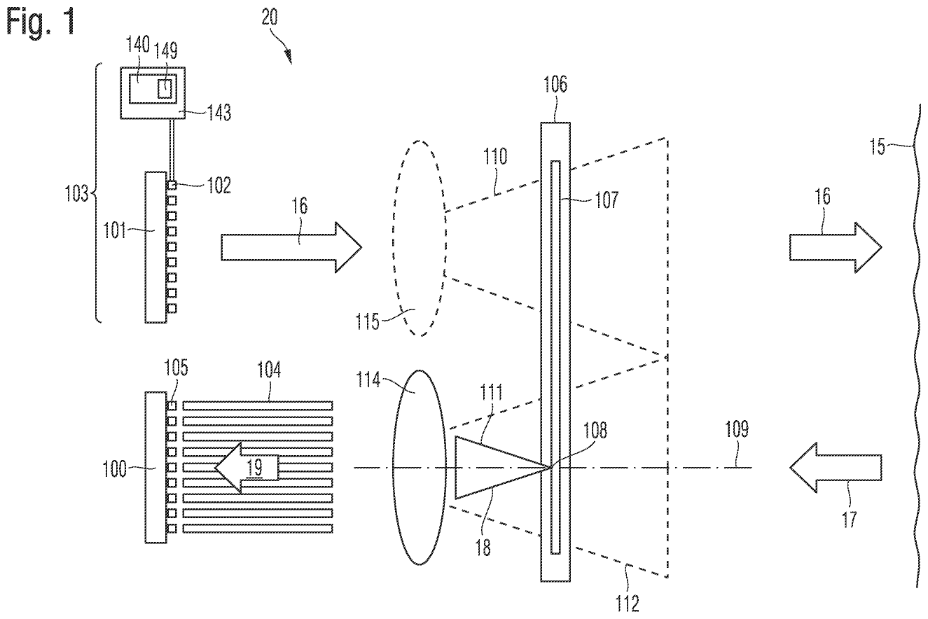

FIG. 1 shows a schematic structure of an optical measurement system according to embodiments. The measurement principle described matches that of an FMCW LIDAR system. As will be explained below, the optical measurement system comprises a device 103 for emitting electromagnetic radiation 16. The optical measurement system 20 further comprises an optical element 106. The optical element 106 comprises a first waveguide 107 and is adapted to transmit a first partial beam of irradiated electromagnetic radiation and to incouple a second partial beam of the electromagnetic radiation into the first waveguide 107 at a first position and to outcouple the same from the first waveguide at a second position.

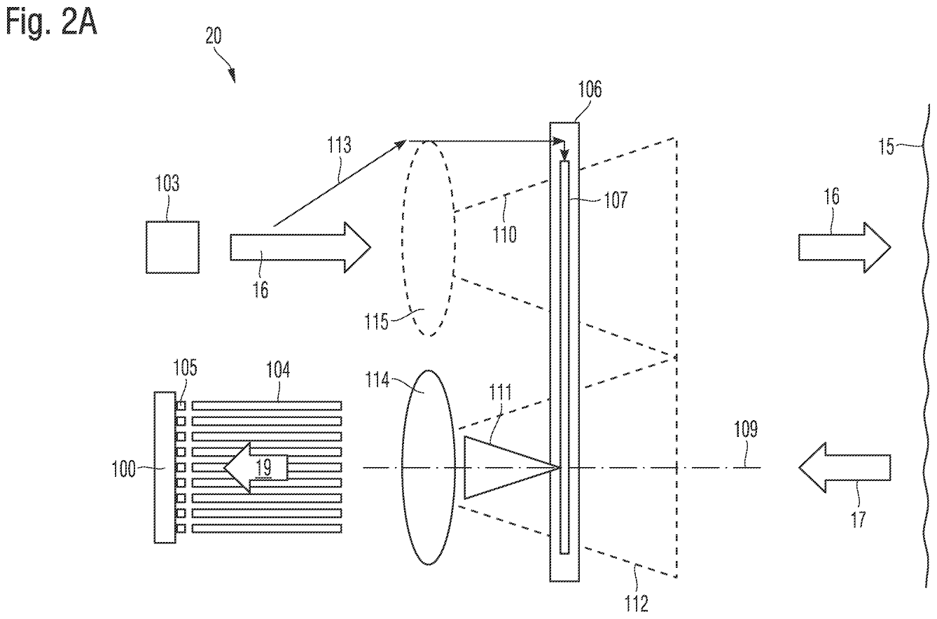

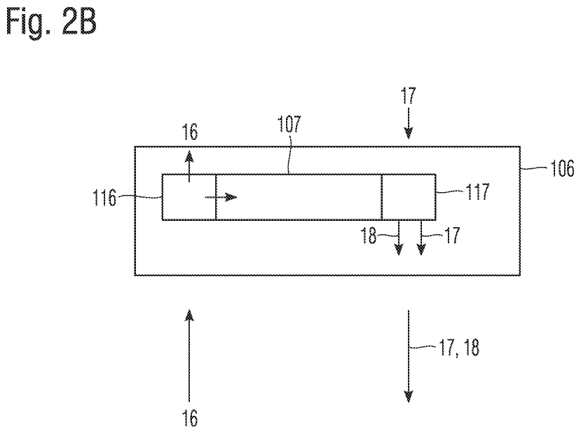

Examples of the structure of an optical element 106 will be described in more detail below with reference to FIG. 2B.

The optical measurement system 20 also comprises a plurality of detectors 105 for detecting signals which are generated by superimposing electromagnetic radiation 17 reflected by an object 15 and electromagnetic radiation outcoupled from the first waveguide 107.

The device 103 for emitting electromagnetic radiation may, for example, comprises an array of laser elements 102. The laser elements 102 may be embodied in any manner. According to embodiments, the laser elements may be embodied as semiconductor lasers, for example as surface-emitting laser diodes (VCSEL, “Vertical-Cavity Surface-Emitting Laser”). If the device 103 is configured as an array of individual laser elements 102, it is possible to irradiate a large-area object by using the emitted laser radiation. The laser elements 102 may be arranged on an emitter substrate 101.

According to embodiments, the device 103 for emitting electromagnetic radiation may moreover comprise a control device 143 adapted to drive each of the surface-emitting laser diodes or laser elements 102. The control device 143 may comprise a modulation device 140, which in turn incudes a current source 149. For example, by using the control device 143, the current intensity impressed into each of the laser elements 102 may be set individually. In addition, the control device 143 may be adapted to simultaneously control at least two, for example all, of the laser elements 102 of the device for emitting electromagnetic radiation. In this manner, a larger field of view 110 is illuminated at the same time, and the measurement process may be performed without using a scanning or deflection unit.

Each laser element 102 may be controlled individually by the control device 143. The control device 143 may be configured such that a plurality of laser elements 102 is controlled simultaneously.

For example, the field of view 110 may be expanded by a third optical element 115, for example a lens or a lens array. The electromagnetic radiation 116 emitted by the device 103 is optionally expanded by the third optical element 115 and irradiated onto the optical element 106. Part of the radiation is transmitted and impinges on an object 15. Another part of the radiation is incoupled into the waveguide 107 and outcoupled again therefrom, as shown in the lower part of FIG. 1.

The light beam 16 emitted by the device 103 is reflected by the object 15 and then re-enters the optical element 106 as a reflected beam 17. As shown in the lower part of FIG. 1, the reflected beam 17 is superimposed with the second partial beam, which has been transmitted through the first waveguide 107. The second partial beam constitutes a reference beam 18. For example, beam 17 is coherent with the reference beam 18 and may be superimposed therewith in a phase-accurate manner.

The reference beam 18 represents an LO (“Local Oscillator”) frequency f_{Lo}. The frequency of the reflected beam 17 is delayed due to the propagation time difference that results from reflection at the object, and corresponds to the frequency fₐ. The difference between fₐ and f_{Lo} is a measure of the movement and distance of the object 15.

By means of suitable superimposition, for example after passing through the second optical element, optionally the waveguide elements 104 and optionally further optical elements, a mixed signal 19 may be generated from the reflected beam 17 and the reference beam 18. The mixed signal 19 may then be detected by the plurality of photodetectors 105. Thereby the difference frequency of the beam 18 and the reflected beam 17 is determined.

The reflected beam 17 exhibits a large field of view 112. The reference beam 18 exhibits a restricted field of view 111. The use of the optical element 114 ensures that an associated local oscillator signal exists for each angle segment by use of which superimposition may take place. Both the reference beam 18 and the reflected beam 17 are then directed onto the plurality of waveguide elements 104. The waveguide elements 104 may represent single-mode waveguides, for example. As a result, only one laser mode passes through the associated waveguide element 104 at a time. As a result, a defined wave front of the irradiated radiation may be transmitted. By means of suitable alignment of the wave fronts, the reflected beam 17 may be mixed with the reference beam 18. The detectors 105 then detect the mixed signal 19.

The mixed signal may be represented as follows:

i_{sig}=iₐ+i_{LO}+2\sqrt{iₐi_{LO}} cos[2π(fₐ−f_{LO})t+(φₐ−φ_{LO})] (1)

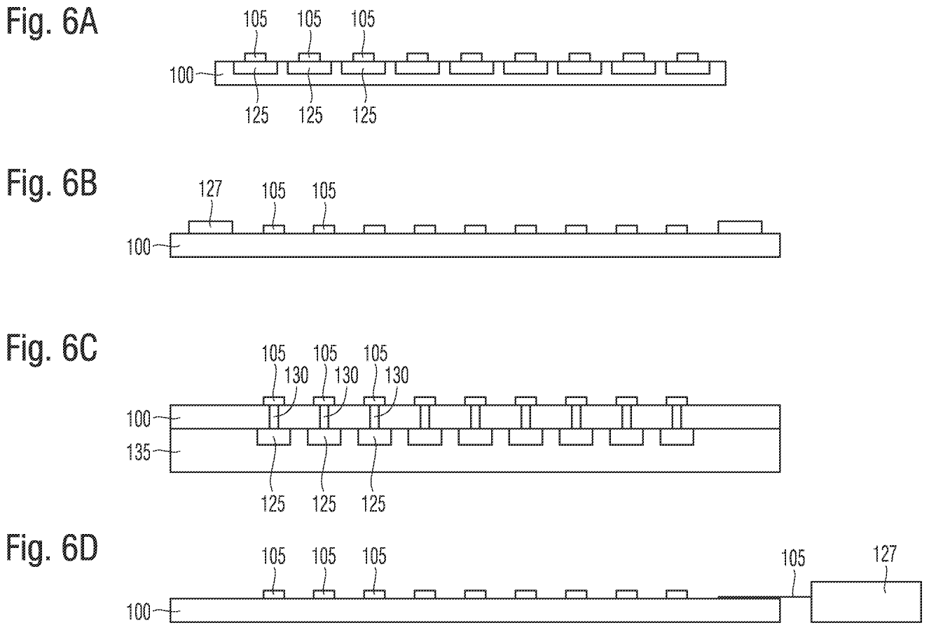

The detectors 105 are adapted to detect a periodic signal the frequency of which corresponds to the difference between fₐ and f_{Lo}. The structure of the detectors 105 will be explained in more detail below with reference to FIGS. 6A to 6D. For example, the plurality of detectors 105 may be arranged on a common substrate 100.

For example, according to embodiments, the emission wavelength of the device 103 is modified continuously and periodically. According to embodiments, the device 103 for emitting electromagnetic radiation may be implemented as a VCSEL. The emission wavelength may be modulated, for example, by modulating the impressed current. For example, a slight modification of the impressed current intensity may result in a frequency modification within the MHz to GHz range. FIG. 1 illustrates a modulation device 140 for modulation of the emitted electromagnetic radiation. For example, the modulation device 140 may comprise a current source 149. The modulation device 140 may, for example, modify the current intensity impressed by the current source 149. As a result, the emission wavelength is modified.

The use of the configuration described, for example, with reference to FIG. 1, ensures that in each angular segment (pixel or detector 105) a reference signal exists that is associated with the reflected beam 17 and can be coherently superimposed on the latter. The reference signal 18 may be picked up from anywhere within the field of view 110 of the emitted beam. For example, it may be picked up at the edge or from the middle.

By using the measurement setup described it is possible to irradiate a large area of an object 15 without a scanning process of an emitted laser beam being necessary. In this manner, measurements, for example LIDAR measurements, may be performed particularly easily and quickly.

The second position 108 where the reference beam is outcoupled from the first waveguide 107 will not necessarily be located at a position of the optical axis 109 of the second optical element 114. According to embodiments, the second position 108 may be shifted along a direction perpendicular to the optical axis 109.

FIG. 2A shows a schematic view of an optical measurement system 20 in which a portion of the emitted beam 16 is branched off before entering the optical element 106 and is then incoupled into a first waveguide 107. The optical element 106 may additionally comprise the first waveguide 107. The other components of the optical measurement system in FIG. 2A are identical to those described with reference to FIG. 1. In particular, the device 103 for emitting electromagnetic radiation may comprise a control device 143 as described with reference to FIG. 1.

FIG. 2B shows a schematic structure of the optical element 106 according to embodiments. For example, a first beam splitter 116 and a second beam splitter 117 may each be arranged on opposite sides of the first waveguide 107. The first and second beam splitters 116, 117 may each be embodied, for example, as prisms, semi-transparent mirrors, gratings, holographic, diffractive, refractive and other optical elements that are adapted to transmit part of the irradiated electromagnetic radiation 16 and to deflect a further part in the direction of the first waveguide 107. In this manner, part of the irradiated electromagnetic radiation 16 is transmitted. A second part is introduced into the waveguide 107 as the reference beam 18 and is later outcoupled again from the second beam splitter 117. The radiation 17 reflected by the object is transmitted by the second beam splitter 117.

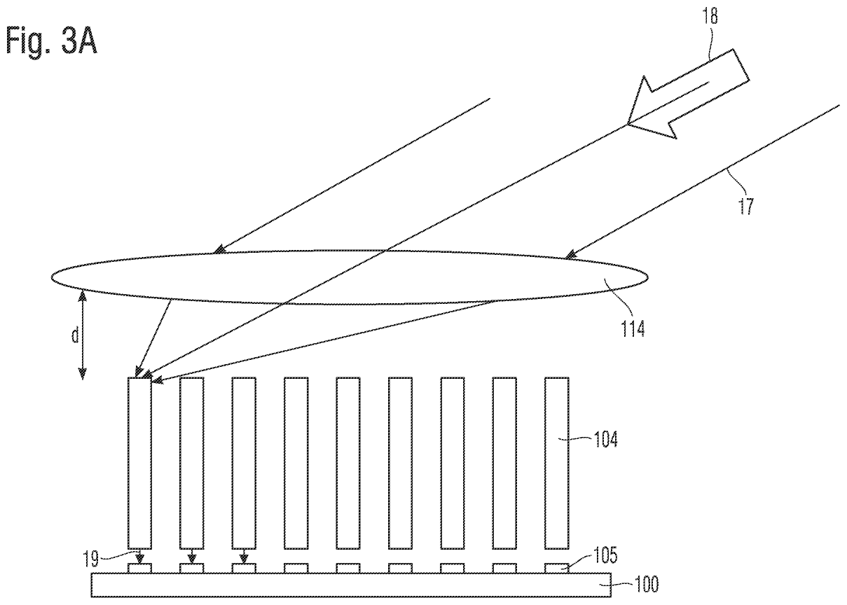

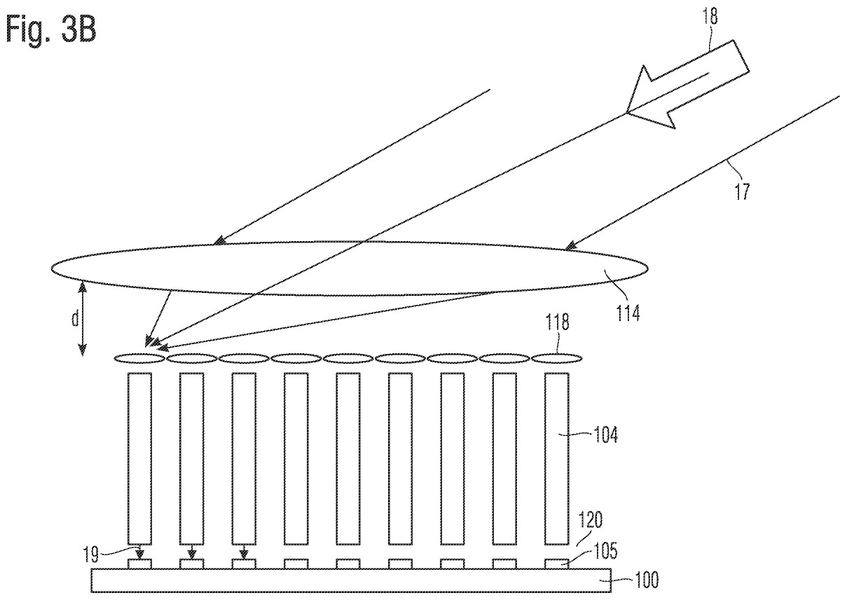

FIG. 3A shows part of the optical measuring system shown in FIG. 1. More precisely, FIG. 3A shows the second optical element 114 and a plurality of detectors 105 which may be formed on a common substrate 100, for example. FIG. 3A further shows an array of waveguide elements 104 arranged between the detector array and the second optical element 114. The waveguide elements 104 are formed, for example, as monomode or single-mode waveguides or as single-mode fibers. By using monomode or single-mode waveguides, a small range of incidence angles may be used. For example, the single-mode waveguides are about 5 to 10 μm in diameter.

By using the single-mode waveguides, the wave fronts are aligned. As a result, the reflected beam 17 and the reference beam 18 may be superimposed and then form a mixed signal 19 which is respectively detected by the plurality of detectors 105. By using the single-mode waveguides 104, the wave fronts may be aligned, thus allowing superimposition, even if the reflected beam 17 and the reference beam 18 are incident on the second optical element 114 at an angle. For example, the distance d between the second optical element 114 and the waveguides 104 is as large as possible in order to make optimum use of the low numerical aperture of the single-mode waveguide 104 as much as possible. This means that, in case of a particularly large distance, beams that are more distant from the axis may be better incorporated despite the low numerical aperture of the single-mode waveguide 104.

For example, the typical distance d may correspond to the quotient of the distance of the respective pixel or detector 105 from the center and the tangent of the angle between the beam to the respective detector 105 and the optical axis 109. The angle may be about 10°. In terms of magnitude, for example, for an array of 20×20 pixels, each of a lateral pixel size of approximately 10 μm, the distance of an off-axis pixel from the center may be approximately 100 μm. In this case, the resulting distance d is about 500 μm. Furthermore, for an array of, for example, 200×200 pixels, a distance of an off-axis pixel from the center is about 1 mm. In this case, the distance d may be about 5 mm.

FIG. 3B shows a schematic cross-sectional view of part of the optical measurement system using first optical micro elements 118. The first optical micro elements 118 are arranged between the waveguide elements 104 and the second optical element 114. For example, the first optical micro elements 118 may be embodied as a micro-lens arrangement, as spherical lenses or as wedge-optical elements. By using the first optical micro elements 118, the wave fronts may be aligned such that even off-axis beams may be incoupled well into the waveguide elements 104.

FIG. 3C shows a view of a part of the optical measurement system according to further embodiments in which, in addition to the first micro elements 118, second micro elements 120 are arranged in each case between the waveguide elements 104 and the detectors 105. For example, the second optical micro elements 120 may each represent collimator or focusing optics. As a result, the mixed signal emerging from the waveguide elements 104 is directed to the respective detectors 105 in an improved manner.

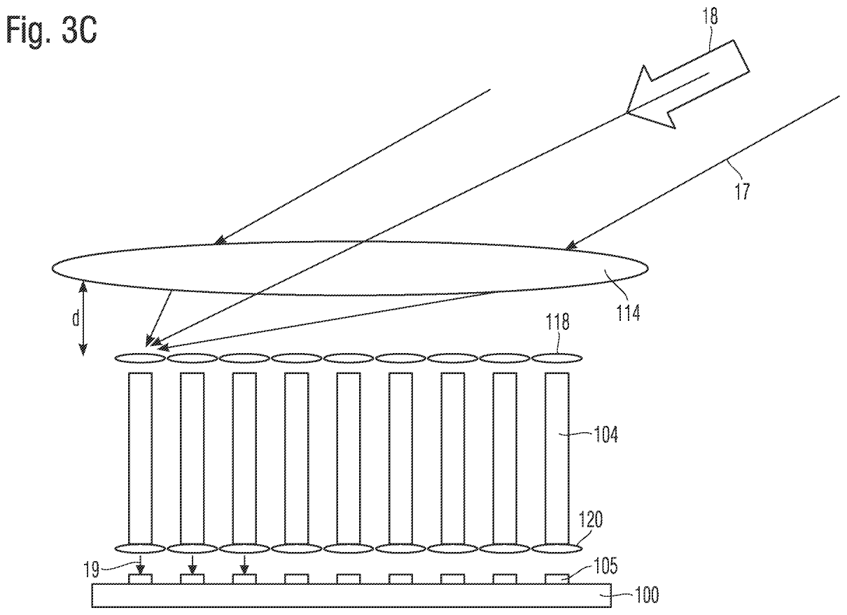

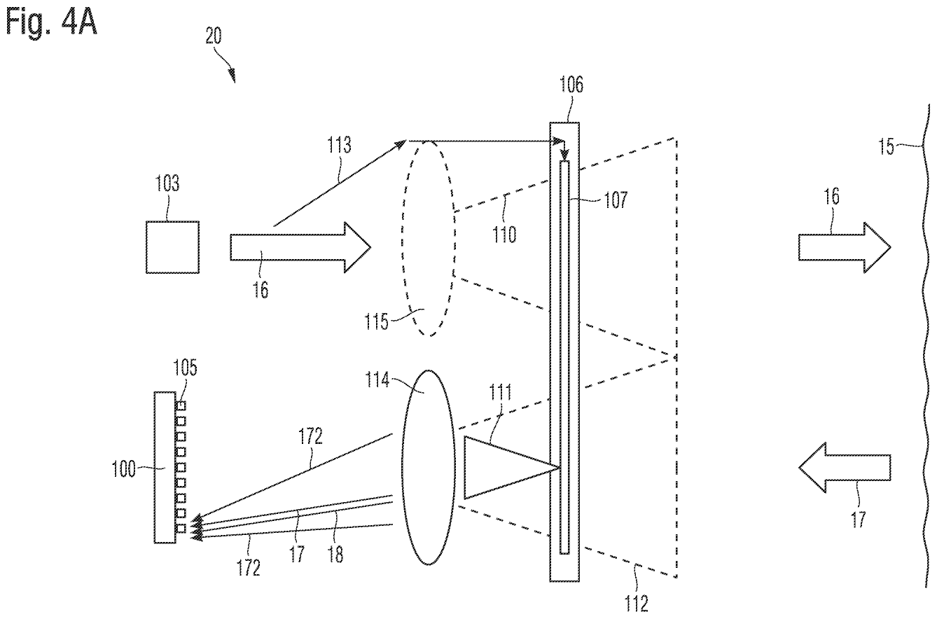

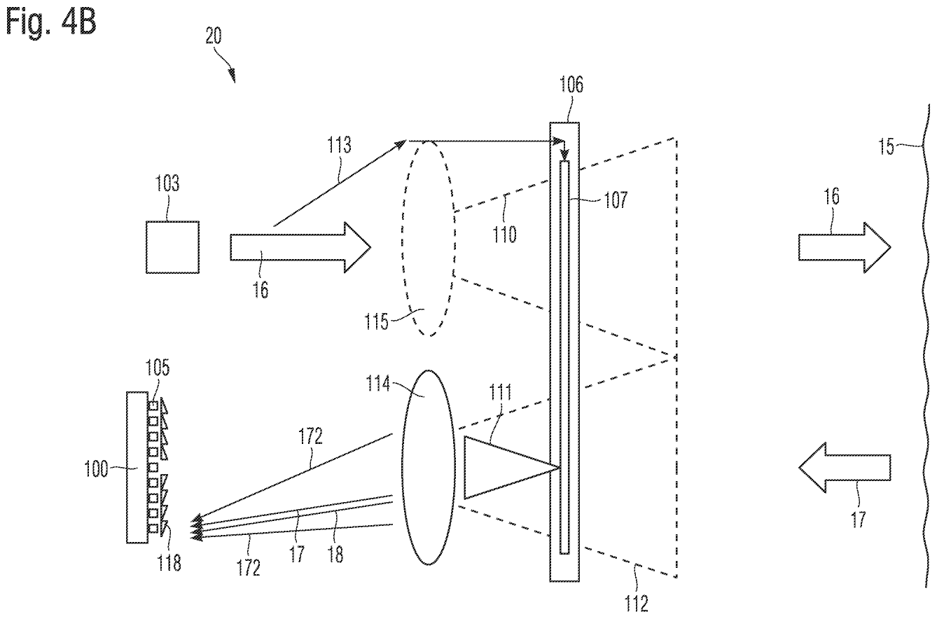

As will be described below with reference to FIGS. 4A and 4B, according to embodiments, the waveguide elements 104 may also be omitted. FIGS. 4A and 4B show elements of FIG. 2A. Obviously the embodiments of FIGS. 4A and 4B may be modified to include elements of FIG. 1 included. In particular, instead of the separate outcoupling device 113, the embodiments may comprise one or more beam splitters 116, 117, as described with reference to FIG. 2B.

The structure of the optical measurement system shown in FIG. 4A is similar to that of the measurement system shown in FIG. 2A. In contrast to FIG. 2A, however, no waveguide elements 104 are provided in this case. In FIG. 4A, a light beam 17 reflected by the object 15 is superimposed with a reference beam 18. It is assumed that there is always one portion within the reflected beam 17 the wavefront of which coincides with the wavefront of a reference beam 18. The off-axis signals 172 do not find any portion within the reference beam 18 having a matching wavefront. The two signals 172 are therefore unmixable signals and are not taken into account in the measurement.

As shown, only part of the electromagnetic radiation emitted by the device 103 for emitting electromagnetic radiation is therefore taken into account in the measurement. By omitting the waveguide elements 104, the system is more cost-effective than the system including waveguide elements 104. However, only part of the emitted electromagnetic radiation is used. The portion of usable electromagnetic radiation depends on the distance between the second optical element 114 and the detector array 105.

As shown in FIG. 4B, the efficiency of the system may be increased by using first optical micro elements 118. For example, in FIG. 4B, a plurality of second optical micro elements 118 may be arranged adjacent to each of the detectors 105 and in the beam path upstream of the detectors 105. For example, the first optical micro elements may be wedge-shaped optical elements. They may each be adapted to deflect obliquely incident optical radiation in the direction of the horizontal direction. By using these wedge-shaped optical elements, it is possible to align the wavefronts such that a larger proportion of the reflected radiation 17 comprises wavefronts that match the direction of the wavefronts of the reference beam 18. In this manner, the signals may be mixed and detected by the detectors 105.

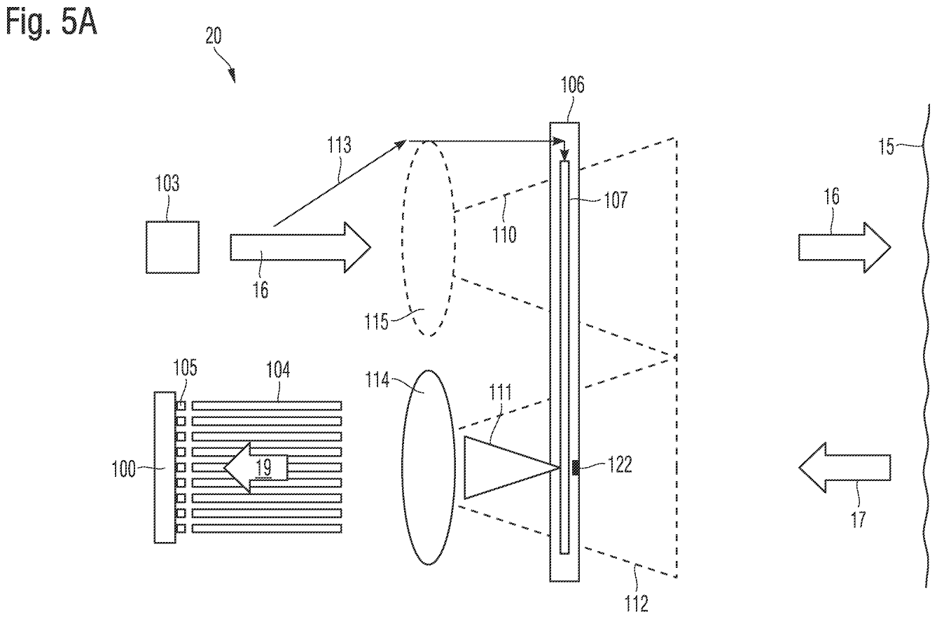

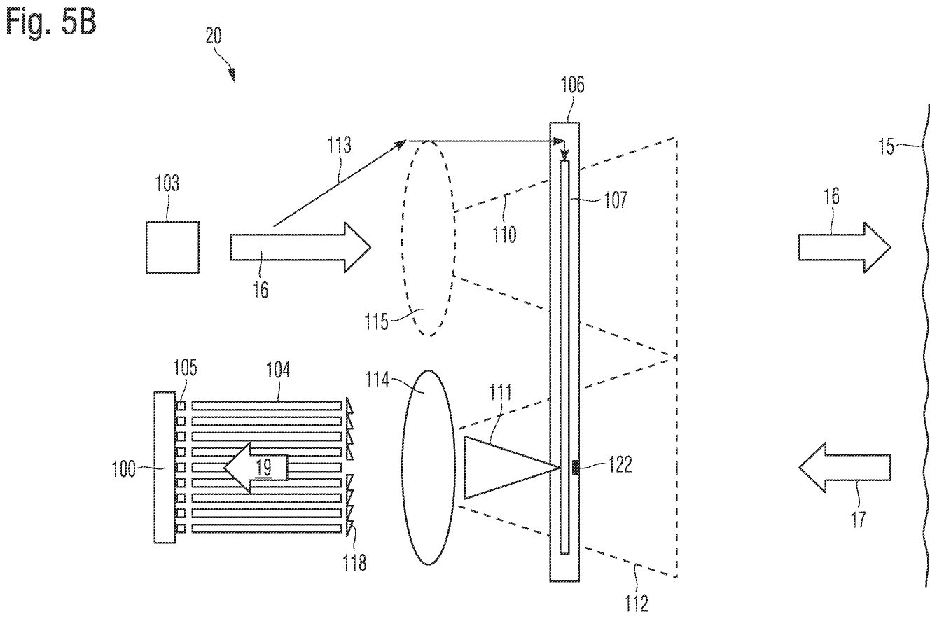

FIG. 5A shows an optical measurement system according to further embodiments. In addition to the components shown in FIG. 2A, the optical measurement system comprises an opaque region 122 in the region of the optical element 106 corresponding to the site where the reference beam 18 is outcoupled from the optical element 106. The outcoupling region corresponds to the second position of the waveguide. For example, this region of the optical element 106 may be made opaque by coating with an absorbent or reflective material. In this manner, part of the reflected beam 17 is blocked. As a result, it is possible to avoid scattering or crosstalk.

FIG. 5B shows an optical measurement system according to further embodiments. In addition to the components shown in FIG. 5A, this system comprises additional first optical micro elements 118. For example, the first optical micro elements 118 may be embodied as wedge-shaped optical elements. The first optical micro elements 118 may be adapted to align the wavefronts such that the reflected beam 17 may be superimposed with the reference beam 18 in an improved manner. The first optical micro elements 118 may be arranged in the beam path upstream of the waveguide elements 104.

Obviously the embodiments of FIGS. 5A and 5B may be modified to include elements of FIG. 1. In particular, instead of the separate outcoupling device 113, the embodiments may comprise one or more beam splitters 116, 117, as described with reference to FIG. 2B.

FIG. 6A shows a schematic cross-sectional view of the plurality of detectors 105 arranged over a substrate 100, for example. For example, a single pixel readout circuit 125 may be associated with each of the detectors 105. For example, each of these pixel readout circuits 125 may be arranged in the substrate 100. In general, according to all of the embodiments described herein, the term “detector” or “photodetector” refers to a general detection device for electromagnetic radiation. The detection device may include semiconductor materials, for example. According to embodiments, the photodetector may include semiconductor materials. For example, the photodetector may include a photodiode comprising a pn junction, a metal-isolator-metal structure, a metal-semiconductor-metal structure, a tunnel junction, Schottky structures, or photoconductive devices. For example, with a suitably selected polarity, the photodetector may have a non-linear current-voltage characteristic.

According to further embodiments, the detectors may be embodied as THz antenna structures and may be able to detect infrared radiation, for example. For example, the electromagnetic radiation emitted by the device 103 for emitting electromagnetic radiation may be in the infrared range. According to embodiments, the detectors may be connected to one another via tunnel diodes. In such an implementation, the difference frequency of the mixed signals as indicated by equation (1) above may be mixed down. For example, the tunnel diodes may be based on the silicon material system. The tunnel diodes may be integrated with the readout electronics.

According to embodiments shown in FIG. 6B, a single detector readout circuit 127 may be provided for the plurality of detectors 105, which is connected to each of the detectors 105, for example.

According to embodiments shown in FIG. 6C, the plurality of pixel readout circuits 125 may be arranged in a circuit substrate 135, for example. The circuit substrate 135 may be connected to the substrate 100 on which the plurality of detectors 105 is arranged by wafer bonding or other wafer connection techniques, for example. For example, respective electrical connectors may be arranged within the substrate 100 and in electrical contact with the plurality of detectors 105. The wafer connection method thus connects the individual detectors 105 to associated pixel readout circuits 125 through electrical connection elements 130.

As shown in FIG. 6D, a detector readout circuit 127 may also be arranged separately and connected to the individual detectors 105 through a control circuit 134.

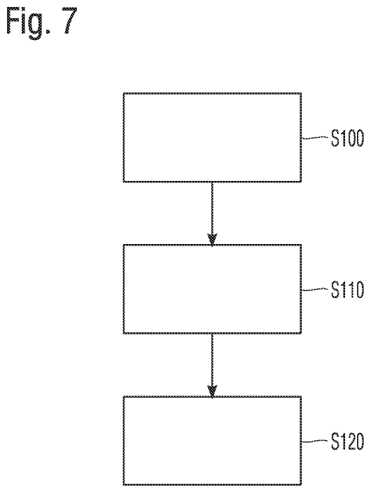

FIG. 7 outlines a method according to embodiments. A method of operating a measurement system as described above comprises simultaneously impressing (S100) a current into a plurality of the laser elements 102, as a result of which electromagnetic radiation 16 is respectively emitted, detecting (S110) a photocurrent by the detectors 105, thereby determining a detection signal, and determining (S120), from the detection signal, a positional relationship or a change in the positional relationship between an object 15 which reflects the electromagnetic radiation 17 and the device 103 for emitting electromagnetic radiation.

For example, the detection signal may be a periodic signal from which a difference between a frequency of electromagnetic radiation 16 emitted by the laser element 102 and the frequency of the electromagnetic radiation 17 reflected by the object 15 may be determined.

Although specific embodiments have been illustrated and described herein, those skilled in the art will recognize that the specific embodiments shown and described may be replaced by a multiplicity of alternative and/or equivalent configurations without departing from the scope of the invention. The application is intended to cover any adaptations or variations of the specific embodiments discussed herein. Therefore, the invention is to be limited by the claims and their equivalents only.

### LIST OF REFERENCES

object
16 emitted beam
17 reflected beam
18 reference beam
19 mixed signal
optical measurement system
100 substrate
101 emitter substrate
102 laser element
103 device for emitting electromagnetic radiation
104 waveguide element
105 detector
106 optical element
107 first waveguide
108 second position
109 optical axis
110 field of view of the emitted beam
111 field of view of the reference beam
112 field of view of the reflected beam
113 separate outcoupling device
114 second optical element
115 third optical element
116 first beam splitter
117 second beam splitter
118 first optical micro element
120 second optical micro element
122 opaque region
125 pixel readout circuit
127 detector readout circuit
130 electrical connection element
134 control circuit
135 circuit substrate
140 modulation device
143 control device
149 current source
172 non-mixable signal
S100 impressing a current
S110 detecting a photocurrent
S120 determining a positional relationship

1. An optical measurement system comprising:
a device for emitting electromagnetic radiation, comprising an array of a plurality of laser diodes;
an optical element comprising a first waveguide and adapted to transmit a first partial beam of irradiated electromagnetic radiation and to incouple a second partial beam of the electromagnetic radiation into the first waveguide at a first position and to outcouple the second partial beam from the first waveguide at a second position; and
an array of a plurality of detectors wherein the first partial beam is reflected by an object and coherently superimposed with electromagnetic radiation outcoupled from the first waveguide, thereby obtaining a mixed signal, the mixed signal being detected by the plurality of detectors.

2. The optical measurement system according to claim 1, wherein the optical element comprises a separate outcoupling device adapted to branch off the second partial beam and incouple the same into the first waveguide.

3. The optical measurement system according to claim 1, further comprising a plurality of waveguide elements arranged in a beam path upstream of the detectors and adapted to feed the signals to be detected to the plurality of detectors.

4. The optical measurement system according to claim 3, wherein the waveguide elements are single-mode waveguide elements.

5. The optical measurement system of claim 3, further comprising a second optical element between the optical element and the plurality of waveguide elements.

6. The optical measurement system according to claim 1, of the preceding claims, comprising a plurality of optical micro elements, each associated with a detector and arranged upstream thereof.

7. The optical measurement system according to claim 1, wherein the optical element comprises an opaque region at the second position on the side facing the object.

8. The optical measurement system according to claim 1, further comprising evaluation electronics adapted to determine a difference frequency between a frequency of the reflected radiation and the electromagnetic radiation outcoupled from the first waveguide.

9. The optical measurement system according to claim 1, further comprising a modulation device adapted to modify a wavelength of the emitted electromagnetic radiation.

10. The optical measurement system according to claim 9, wherein the modulation device comprises a current source and is adapted to modify a current intensity impressed into the laser diodes.

11. The optical measurement system according to claim 1, wherein several of the plurality of laser diodes are capable of being controlled simultaneously.

12. A LIDAR system, comprising the optical measurement system according to claim 1.

13. A method of operating the measurement system according to claim 1, wherein the method comprises:
simultaneously impressing a current into the array of a plurality of laser diodes, as a result of which electromagnetic radiation is respectively emitted;
detecting a photocurrent by the detectors, thereby determining a detection signal; and
determining, from the detection signal, a positional relationship or a change in the positional relationship between an object which reflects the electromagnetic radiation and the device for emitting electromagnetic radiation.

14. The method of claim 13, wherein the detection signal is a periodic signal from which a difference is determined between a frequency of electromagnetic radiation emitted by the laser diode and the frequency of the electromagnetic radiation reflected by the object.
